(19) United States
(12) Patent Application Publication
(10) Pub. No.: US 2018/0352623 A1
(43) Pub. Date: Dec. 6, 2018

(54) UTILIZING COMPUTING RESOURCES EMBEDDED IN LED LAMPS

(71) Applicant: Lunera Lighting, Inc., Santa Clara, CA (US)

(72) Inventor: Ajay Malik, Santa Clara, CA (US)

(21) Appl. No.: 16/000,838

(22) Filed: Jun. 5, 2018

Related U.S. Application Data
(60) Provisional application No. 62/515,509, filed on Jun. 5, 2017.

(51) Int. Cl. H05B 33/08; H05B 37/02

(52) U.S. Cl. CPC H05B 33/0845; H05B 37/0272; H05B 37/0227

(57) ABSTRACT

A method to share the computing resources embedded in the lighting device with an external server is provided. Whenever an application in lighting device determines a computing resource in idle state, it connects with the external server and share the idle computing resource with the external server. The external applications interacting with the external server can then utilize the shared computing resource.

### CROSS-REFERENCE TO RELATED APPLICATION

This application claims benefit to U.S. Provisional Patent Application No. 62/515,509, filed Jun. 5, 2017, entitled “Utilizing Computing Resources Embedded in LED Lamps”, the content of which is hereby incorporated by reference herein in its entirety.

### FIELD OF THE INVENTION

The present invention generally relates to utilization of computing resources in a lighting technology and, more particularly, to aggregate the computing resources available in Lighting Devices in a facility in a single abstracted pool of resources.

### BACKGROUND

Now-a-days the computing devices, such as computers, mobile phone device, tablet, data, laptops, processor, information processing system, touchpad, microphone etc. and various other machine learning applications rely on microprocessors, associated chip sets, and memory chips to perform most of their processing functions. Because these devices are integrated circuits formed on semiconducting substrates, the technological improvements of these devices have essentially kept pace with one another over the years. With the increasing trend of Internet and use of various applications that need high processing power and storage space, these devices takes more time to execute the instruction due to the dramatically inferior capabilities processing unit and the user experience lagging in their performances.

Additionally, today's organizations deal with big data, analytics and machine learning applications. For these applications to succeed, they need higher processing speed and low latency. Not only that, they need this processing unit as close to the application as possible.

With the rise of cloud computing, widespread use of cloud processor has happened/has been happening. However, there is latency to access these processors/processing unit in cloud. The drawback to cloud computing is the absence of a uniform protocol for structuring operations. Also different vendors provide different means to access their services. Thus users lack portability when designing for cloud computing. And, there may be times, when the owner of the data has concern about privacy of the data may not want be even send out of the premises for compute purposes.

The present invention provides a solution that overcomes the aforementioned problems in the computing devices and applications space, where the computing device has limited computing resources and need to be provided these resources externally. Generally lighting devices are installed throughout a facility in high density and remains frequently ON without relying on any battery resources, therefore, it is economically viable to utilize the embedded computing resources and shared with an external device or an application.

### SUMMARY OF THE INVENTION

In a first aspect of present invention, a lighting device is provided. The lighting device comprising: a) a lighting device embedded computing resources comprising processor, memory and storage; b) a lighting device embedded communication interface to provide connectivity that enables the lighting device to connect to an external server; c) a lighting device embedded client application that monitors the usage of said embedded computing resources and on detection of a computing resource as idle, connects with the external server to share the idle computing resource. The communication interface in the lighting device is a Wi-Fi radio or an Ethernet port. The one or more computing resources of the lighting device comprises a processing unit, a memory or storage. An owner of the lighting device has to register with the external server to share the idle computing resource.

In a second aspect of present invention, a system for sharing embedded computing resources in a lighting device is provided. The system comprising: a plurality of lighting devices with one or more embedded computing resources installed in a facility, said plurality of lighting devices are connected to a network; a resource sharing server connected to the network, wherein one or more facility can register with the resource sharing server to share said one or more embedded computing resources; a client application in each of the plurality of lighting device that monitors the usage of said one or more computing resources, and on detection of a computing resource as idle, connects with the resource sharing server to share the idle computing resource. The system further comprises one or more external applications interacting with the resource sharing server that exploit the idle computing resources in the lighting devices. The one or more computing resources of the lighting device comprises a processing unit, a memory or storage. The system further comprises an application that participates with computing resources inside other lighting device as a distributed kernel that abstracts the one or more computing resources in a single pool. The system further comprises an application that acts as an agent to the resource sharing server that provides an aggregated view of available computing resources to the one or more external application interacting with the resource sharing server to exploit the idle computing resources in the lighting device. An owner of the facility can utilize the embedded computing resource in the lighting device for internal application or share the embedded computing resources with other businesses.

In a third aspect of present invention, a method for sharing embedded computing resources in a lighting device is provided. The method comprising: connecting a plurality of lighting devices with one or more embedded computing resources installed to a network; registering by one or more facility with a resource sharing server to share said one or more embedded computing resources; monitoring by a client application in each of the plurality of lighting device, the usage of said one or more computing resources; wherein on detection of a computing resource as idle, the client application connects with the resource sharing server to share the idle computing resource. The method further comprises: providing one or more external applications interacting with the resource sharing server that exploit the idle computing resources in the lighting devices. The one or more computing resources of the lighting device comprises a processing unit, a memory or storage. The method further comprises: providing an application that participates with computing resources inside other lighting device as a distributed kernel that abstracts the one or more computing resources in a single pool. The method further comprises: providing an application that acts as an agent to the resource sharing server that provides an aggregated view of available computing resources to the one or more external application interacting with the resource sharing server to exploit the idle computing resources in the lighting device. The owner of the facility can utilize the embedded computing resource in the lighting device for internal application or share the embedded computing resources with other businesses.

### BRIEF DESCRIPTION OF THE DRAWINGS

The preferred embodiment of the invention will hereinafter be described in conjunction with the appended drawings provided to illustrate and not to limit the scope of the invention, wherein like designation denote like element and in which:

FIG. 1 illustrates a systematic representation of a typical lighting device and computing resources embedded in the lighting device in accordance with an embodiment of the present invention.

FIG. 2 illustrates a system architecture for sharing embedded computing resource of lighting devices in a facility, in accordance with an embodiment of the present invention.

FIG. 3 shows a block diagram where an external application shares the resources of a lighting device in accordance with an embodiment of present invention.

FIG. 4 shows a block diagram where a distributed kernel abstracts the computing resources from a plurality of lighting devices in accordance with an embodiment of present invention.

FIG. 5 shows a block diagram where an external server aggregates the computing resources form a plurality of lighting devices in a facility in accordance with an embodiment of present invention.

### DETAILED DESCRIPTION OF THE INVENTION

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances well known methods, procedures and components have not been described in details, so as not to unnecessarily obscure aspects of the embodiments of the invention.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, and is not intended to limit the invention to the specific embodiments illustrated by the figures or description below. For example, Wi-Fi is used as a wireless communication protocol from the Lighting Device however; other wireless or wired communication protocols could be employed without departing from the scope of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention provides a system and a method to utilize embedded computing resources inside a lighting device and share the embedded computing resource with other external computing devices and applications. The lighting devices are arranged in a network in a facility using a communication protocol, which can be either a Wi-Fi, a Bluetooth, a Radio network identification, local area network, Zigbee network, near-field communication or other known communication protocol. The communication between the lighting devices enables the lighting devices to share different components/resources within and outside the network. The lighting device of the invention may include, but is not limited to a LED lamp or LED light bulb, incandescent lamp, Compact Fluorescent Lamp (CFL), Halogen lamp, Metal halide Lamp, tube light, Neon lamp, High intensity discharge lamp, Low pressure sodium lamp or any other lighting system known in the art.

The method involves integrating the embedded computing resources inside one or more lighting device in a facility and then aggregating the computing resources to be utilized by the external computing devices and application. The embedded computing resources inside the lighting device may comprise processing space, memory, storage and other resources. The external application is a computer program designed to run on computing devices. The computing devices may include, but not limited to computer, mobile phone device, tablet, data processor, information processing system, touchpad, microphone etc.

In an embodiment of the present invention, the Lighting Devices comprises a processing unit such as CPU, storage/memory as well as a communication port such as Wi-Fi. The lighting device also comprise a Lamp Share Client application that enables the lighting device to share the embedded computing resources. The Lamp Share Client application enables the Lighting Devices to register as a shared resource provider with an external server. Whenever, the lighting device is having idle computing time, the lamp share client application dedicates the embedded resources to the external server. The computing resources can then be utilized by any external applications that are registered with the external server as consumers. In an embodiment of present invention, a distributed kernel application is run across a group of lighting devices. The kernel application abstracts the computing resources away from the lighting devices, thus enabling fault-tolerant and elastic distributed system to be easily built and run effectively.

Other aspects and advantages of the described embodiments will become apparent from the following detailed description, taken in conjunction with the accompanying drawings, illustrating by way of example the principles of the described embodiments.

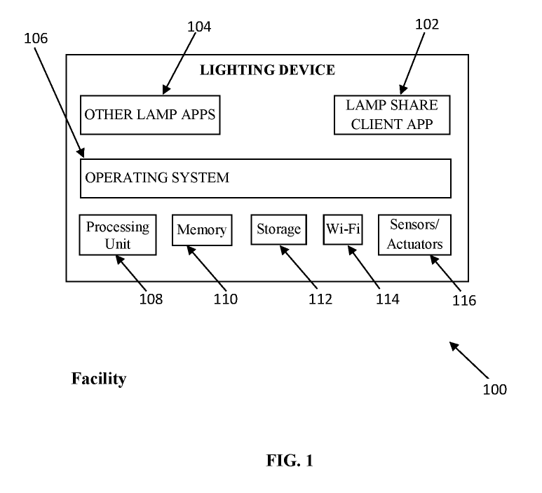

FIG. 1 illustrates a systematic representation of a typical lighting device and computing resources embedded in the lighting device in accordance with an embodiment of the present invention. The Lighting Device 100 may include, but is not limited to, LED lamp or LED light bulb, incandescent lamp, Compact Fluorescent Lamp (CFL), Halogen lamp, Metal halide Lamp, tube light, Neon lamp, High intensity discharge lamp, Low pressure sodium lamp etc. The Lighting Device 100 includes a Lamp Share Client 102 application that enables the Lighting Device 100 to register with a Resource sharing server and share its different components/resources with an external applications or a device. Whenever the lighting device is idle, the Lamp Share client application 102 during the idle computing time dedicates the embedded computing resources to an external application as agreed upon with the resource sharing server. The lighting device 100 also comprises an operating system 106, processing unit 108, a memory 110, a storage 112, a Wi-Fi radio 114, one or more sensors/actuators 116 and other lamp applications 104 required for functioning of the lighting device. The Wi-Fi 114 is used to connect all the Lighting Devices 100 in the facility in a network and to connect with an Access point that provide internet connectivity to the lighting device 100. The Other Lamp Apps 104 in the Lighting device 100 may performs various functions such as but not limited to, control the intensity and color of light, control the input that Lighting Device 100 receives, control operating voltage or current or temperature, turn on-off etc. It may have the ability to change the complete application of the lighting device on demand.

The Processing Unit 108 executes instructions, codes, computer programs, or scripts that it accesses from hard disk, floppy disk, optical disk (or other secondary storage), ROM, RAM, or the network connectivity devices like external applications. The Processor Unit 108 may include any suitable computing device, such as a microprocessor, microcontroller, field programmable gate array, application specific integrated circuit, or digital signal processor. The network connectivity devices may enable the Processor Unit 108 to communicate over the Internet or one or more intranets. With such a network connection, the Processor Unit 108 can receive information from a network or output information to a network in the course of performing the above-described functions.

The Memory 110 may be a part of a data storage module or a volatile memory. Examples of volatile memory include random access memory (RAM), such as static RAM (SRAM) or dynamic RAM (DRAM). The Memory 110 is accessible by the processor unit and stores programming for execution and data for processing or that has been processed by the processor.

The Memory 110 may be implemented as electrical, magnetic or optical memory, or any combination of these or other types of storage devices. Moreover, the term “memory” should be construed broadly enough to encompass any information able to be read from or written to an address in the addressable space accessed by a processor. With this definition, information on a network is still within Memory 110, as the processor 108 may retrieve the information from the network.

The Operating System 106 is a program that manages the various resources of the Lighting Device 100. Typically the resources include the Processing Unit 108 that handles all instructions it receives from hardware and software running in the Lighting Device 100, Storage 112, Wi-Fi radio 114 and Sensors/Actuators 116. The operating system 106 enables execution of the various resources/applications, both for local functions and for communications using the interface. The processing unit 108 is capable of providing control signals and/or performing operations in response to input signals from Other Lamp Apps 104 and executing instructions stored in the Memory 110.

The Storage 112 may be a computer-readable medium and/or any recordable medium (e.g., ROM, EPROM, EEPROM, Flash memory, removable memory, CD-ROM, hard drives, DVD, floppy disks or memory cards). Any medium known or developed that can store information suitable for use with a computer system may be used as the computer-readable medium and/or memory.

The Wi-Fi 114 makes the Lighting Device 100 compatible to the Internet via a WLAN and a Wi-Fi access point in the facility. The Lighting Device 100 may have one or more Wi-Fi 114 radios. Wi-Fi 114 most commonly uses the 2.4 GHz and 5.8 GHz radio bands. According to one aspect, Wi-Fi 114 may include a radio-frequency (RF) transceiver. Examples of RF transceivers are transceivers for wireless networking, transceivers for cellular or mobile networks, transceivers for near-field communication (NFC), and transceivers for radio-frequency identification (RFID). The Wi-Fi 114 may support the Internet protocol (IP) or other wireless data protocols. Other types of wireless transceivers and/or wireless protocols are within the scope of the subject matter claimed.

The Sensors/Actuator 116 monitors/checks the Wi-Fi network available in the facility. It is equipped with Wi-Fi radios designed to measure the RF environment as well as perform network connectivity and other tests against the existing Wi-Fi infrastructure. It continuously monitors the Wi-Fi performance when connected through the APs deployed in their vicinity.

The Sensors/Actuator 116 in the Lighting Devices 100 is used to monitor one or more external conditions and availability of Wi-Fi signal in the vicinity of Lighting Device 100. The Sensors/Actuator 116 may include, but not limited to, RF sensors, IR sensors, light sensors, temperature sensors, pressure sensors, proximity sensors, LDR sensors, ultrasonic sensors, touch sensors etc.

Sensing and network communications, however, have focused on the lighting functions/applications of the lighting devices. For example, sensors may be provided in a Lighting Device 100 to detect parameters relevant to control operation of the Lighting Device 100. The Processor Unit 108 in the device controls the source(s) of the device in response to the sensor inputs.

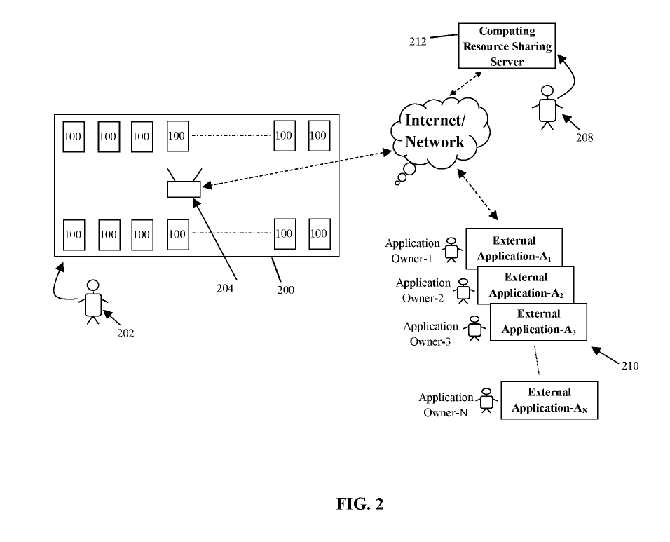

FIG. 2 illustrates a system architecture for sharing embedded computing resource of lighting devices in a facility, in accordance with an embodiment of the present invention. A plurality of lighting devices 100 are installed in a facility 200. The facility can be a residential, commercial, official, medical, education, industrial or government owned or any other kind of property. The resource owner 202 is a user having ownership of the lighting devices 100 and used the lighting device for lighting and sensing in the facility 200. The facility has a Wi-Fi network that allows connectivity to internet. The lighting devices 100 uses a Wi-Fi access point 204 installed in the facility to connect to the internet. The plurality of lighting device 100 in the facility 200 have computing resources embedded in it which are used by the lighting devices for performing different functions. During the idle computation time, the embedded computing resources remain idle, and hence can be used for other functions. The resource owner 202 can share these resources with any external application or devices or server in exchange of some financial arrangement.

The system comprises a computing resources sharing server 212 which is owned by a sharing service owner 208. The computing resource sharing server is a platform where different users can share their additional computing resources as well as utilize the additional sources shared by other users. The computing resource server is a collaborative service provider where users can exchange their additional resources with other users that require additional resources. The computing resource sharing server is connected to Internet and hence can be accessible by a device which is connected to Internet. The computing resource sharing server 212 allows the resource owner 202 who wish to share the embedded computing resources in lighting devices in the facility to register as a resource provider. The lighting device 100 has a Lamp share client application that act as a client to the computing resource sharing server 212. The resource owner 202 can register the lighting device 100 with computing resource sharing server 212 through lamp share client application.

In an embodiment the resource owner 202 registers with the computing resource sharing server 212 so as to make the computing resource available in the facility for share use. The resource owner 202 and the computing resource sharing server may enter into financial agreement or other agreement for sharing the available resources. In another embodiment, the sharing arrangement is based on voluntary basis where no money is exchanged. The computing resource sharing service owner may pay to resource owner 202 based on the computing resources used. The financial arrangement to share available resources may involve exchange of other products or services.

In an embodiment, a plurality of resource owners 202 can register with the computing resource sharing server 212 so as to share the resources in lighting devices with the resource sharing server. In this manner, the computing resource sharing server 212 becomes an aggregated pool of different type of computing resources.

The computing resource sharing server 212 is a collaborative space, therefore, a plurality of applications 210 that require external additional computing resources for performing their function register with computing resource sharing server 212. The agreement between the external application owners and the computing resource sharing server can be a financial arrangement or on voluntary basis.

When the computing resources in the lighting devices are idle, the lamp share client application 102 shares the idle resources with the computing resource sharing server 212 through Internet which can then be accessed by external application using Internet.

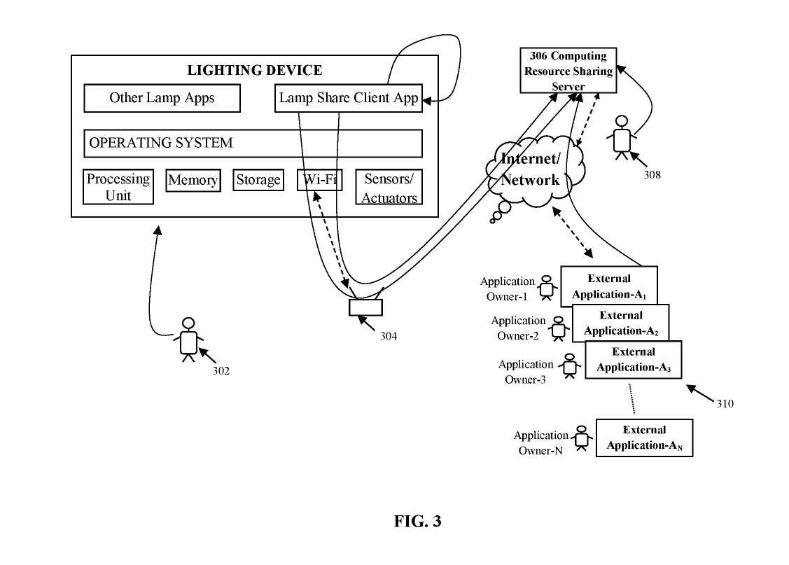

FIG. 3 shows a block diagram where an external application shares the resources of a lighting device in accordance with an embodiment of present invention. The lighting device installed in the facility comprises various computing resources, such as processing unit, memory storage and other resources. When an owner 302 of the lighting device wishes to share the resources of the lighting devices, it enters into an agreement with computing resource sharing server 306. The Lamp share client application of the lighting device registers with the computing resource sharing server. The lamp share client application continuously monitors availability of resources in the lighting device. When any of the computing resource in the lighting device is idle, it informs the computing resource sharing server about the idle resource available in the lighting device. The lighting device is connected to a Wi-Fi access point 304 which provide connectivity to Internet. The computing resource sharing server can be accessible through internet.

On receiving the intimation from Lamp share client, the computing resource sharing server requests the lamp share client application of the lighting device to share the available computing resources.

A plurality of external applications 310 that require external computing resources are connected to the computing resource sharing server and utilize the available computing resources for performing their functions.

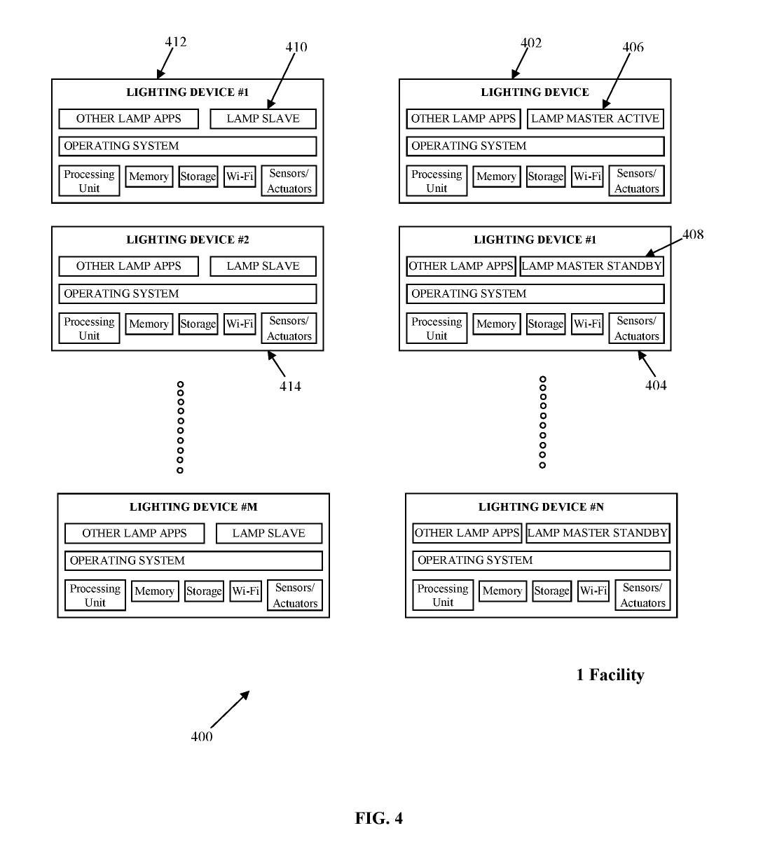

FIG. 4 shows a block diagram where a distributed kernel abstracts the computing resources from a plurality of lighting devices in accordance with an embodiment of present invention. Referring to FIG. 4, the Facility 1 is the location where one or more Lighting Device is installed. A kernel is an application required to make computing platform inside the lighting devices accessible to users. In this embodiment, kernel application runs a program or code or instructions to categorize some lighting device as master and some as slave. Master slave topology is preferred for synchronization of different modules of a single system to execute instructions sequentially. For running Wi-Fi applications, master led lamps are in Active Mode or Standby mode. In this embodiment, some Lighting Devices in the facility are working as Master Lighting Device (such as lamp 402, 404 . . . N) and working in Active Mode 406 or Standby Mode 408. And, remaining Lighting Devices working as Slave Lighting Device (such as lamp 412, 414 . . . M). The Lamp Slave Application 410, Lamp Master application 406 in active mode and Lamp Master application 408 in standby mode all together abstract all the resources present in the corresponding lighting device as one pool of computing resource—Processing Unit, Memory, Storage, Sensor etc. Now all these Lighting Devices appear as one operating system for executing any program requested by internal or external application. Whenever master lighting device fails to operate, a signal is provided to slave lamp to act in active mode. This change of topology allows user to access computing resources without any failure. These applications may be for internal use as deployed by the Lighting Device Resource Owner or external applications. Lighting Device Resource Owner may have some sort of financial arrangement with the External Application owners.

In one embodiment, the arrangement is just a volunteer no cost model where no money is exchanged and in other embodiments Application Owners pay to Lighting Device Resource Owner based upon the computing resources used. The financial arrangements are not limited to the above described examples.

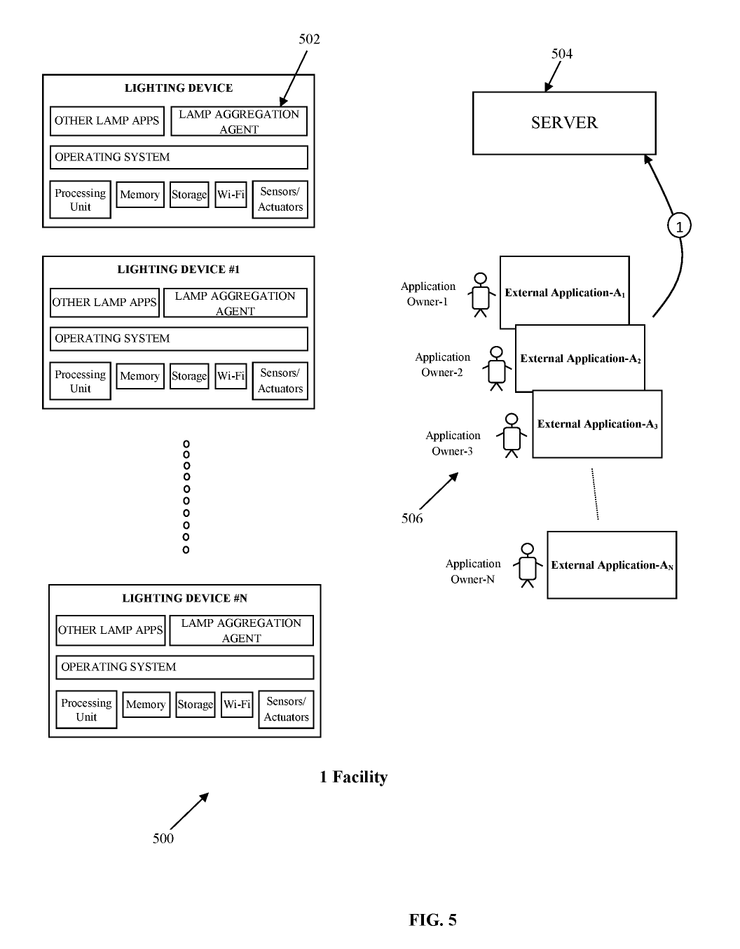

FIG. 5 shows a block diagram where an external server aggregates the computing resources form a plurality of lighting devices in a facility in accordance with an embodiment of present invention. The one or more External Applications (A1, A1, A1 . . . AN) 506 running outside of the Lighting Device is a computer program designed to run on computing devices. The external applications 506 are in need of additional computing sources which can be shared by the plurality of lighting devices. The plurality of lighting devices share their available computing resources to a server 504 through internet. The one or more external applications 506 are also connected to the server 504 through internet. A Lamp Aggregation Agent 502 allows external applications 506 to access its different components (such as but not limited to storage, processing unit, Wi-Fi etc.) by using communication means like Wi-Fi, Zigbee etc. The Server 504 communicates with the Lamp Aggregation Agent 502 and provides an aggregated view of all resources. The Server may be installed in the same facility or a remote server. The plurality of External Applications (A1, A1, A1 . . . AN) 506 then use some application programming interface/APIs to talk to the Server 504 and use the aggregated computing resources of lighting devices for their use.

Additionally, the applications may be for internal use as deployed by the Lighting Device Resource Owner or external applications.

Although specific embodiments have been described and illustrated, the described embodiments are not to be limited to the specific forms or arrangements of parts so described and illustrated. The specification and drawings are accordingly to be regarded in an illustrative manner and are not intended to limit the scope of the appended claims.

We claim:

1. A lighting device comprising
a) a lighting device embedded computing resources comprising processor, memory and storage;
b) a lighting device embedded communication interface to provide connectivity that enables the lighting device to connect to an external server;
c) a lighting device embedded client application that monitors the usage of said embedded computing resources and on detection of a computing resource as idle, connects with the external server to share the idle computing resource.

2. The lighting device of claim 1, wherein the communication interface is a Wi-Fi radio or an Ethernet port.

3. The lighting device of claim 1, wherein the one or more computing resources of the lighting device comprises a processing unit, a memory or storage.

4. The lighting device of claim 1, wherein an owner of the lighting device registers with the external server to share the idle computing resource.

5. A system for sharing embedded computing resources in a lighting device, said system comprising:
a plurality of lighting devices with one or more embedded computing resources installed in a facility, said plurality of lighting devices are connected to a network;
a resource sharing server connected to the network, wherein one or more facility can register with the resource sharing server to share said one or more embedded computing resources;
a client application in each of the plurality of lighting device that monitors the usage of said one or more computing resources, and on detection of a computing resource as idle, connects with the resource sharing server to share the idle computing resource.

6. The system of claim 5, further comprising one or more external applications interacting with the resource sharing server that exploit the idle computing resources in the lighting devices.

7. The system of claim 5, wherein the one or more computing resources of the lighting device comprises a processing unit, a memory or storage.

8. The system of claim 5, further comprising an application that participates with computing resources inside other lighting device as a distributed kernel that abstracts the one or more computing resources in a single pool.

9. The system of claim 5, further comprising an application that acts as an agent to the resource sharing server that provides an aggregated view of available computing resources to the one or more external application interacting with the resource sharing server to exploit the idle computing resources in the lighting device.

10. The system of claim 5, wherein an owner of the facility can utilize the embedded computing resource in the lighting device for internal application or share the embedded computing resources with other businesses.

11. A method for sharing embedded computing resources in a lighting device, said method comprising:
connecting a plurality of lighting devices with one or more embedded computing resources installed to a network;
registering by one or more facility with a resource sharing server to share said one or more embedded computing resources;
monitoring by a client application in each of the plurality of lighting device, the usage of said one or more computing resources;
wherein on detection of a computing resource as idle, the client application connects with the resource sharing server to share the idle computing resource.

12. The method of claim 11, further comprising: providing one or more external applications interacting with the resource sharing server that exploit the idle computing resources in the lighting devices.

13. The method of claim 11, wherein the one or more computing resources of the lighting device comprises a processing unit, a memory or storage.

14. The method of claim 11, further comprising: providing an application that participates with computing resources inside other lighting device as a distributed kernel that abstracts the one or more computing resources in a single pool.

15. The method of claim 11, further comprising: providing an application that acts as an agent to the resource sharing server that provides an aggregated view of available computing resources to the one or more external application interacting with the resource sharing server to exploit the idle computing resources in the lighting device.

16. The method of claim 11, wherein an owner of the facility can utilize the embedded computing resource in the lighting device for internal application or share the embedded computing resources with other businesses.
